(19) United States
(12) Patent Application Publication
(10) Pub. No.: US 2003/0107800 A1
(43) Pub. Date: Jun. 12, 2003

(54) System and method for controlling and/or displaying microscope functions

(76) Inventors: Gerhard Doering, Schloeben (DE); Horst Bruch, Jena (DE); Matthias Gonschor, Gleichen (DE); Ralf Boecker, Goettingen (DE); Carsten Hoyer, Juehnde (DE); Michael Wagener, Goettingen (DE); Leander Dietzsch, Jena (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/149,057

(22) PCT Filed: Oct. 2, 2001
(86) PCT No.: PCT/EP01/11356

(30) Foreign Application Priority Data
Oct. 6, 2000 (DE) 10050822.7
Feb. 2, 2001 (DE) 10106275.3

(51) Int. Cl. G02B 21/36; G02B 23/00; G02B 21/00; G02B 21/06

(52) U.S. Cl. 359/388; 359/363; 359/368; 359/381; 359/385

(57) ABSTRACT

Arrangement for controlling and/or displaying microscope functions, preferably in an inverted microscope, wherein a display is provided at or near the eye level of a user, and the display can be removed. The adjustment and/or storage of microscope functions is carried out via the display. In a method for controlling microscope functions, an automatic switching of the light source and/or illumination optics is carried out to pre-stored values and/or positions when a reflector turret is switched.

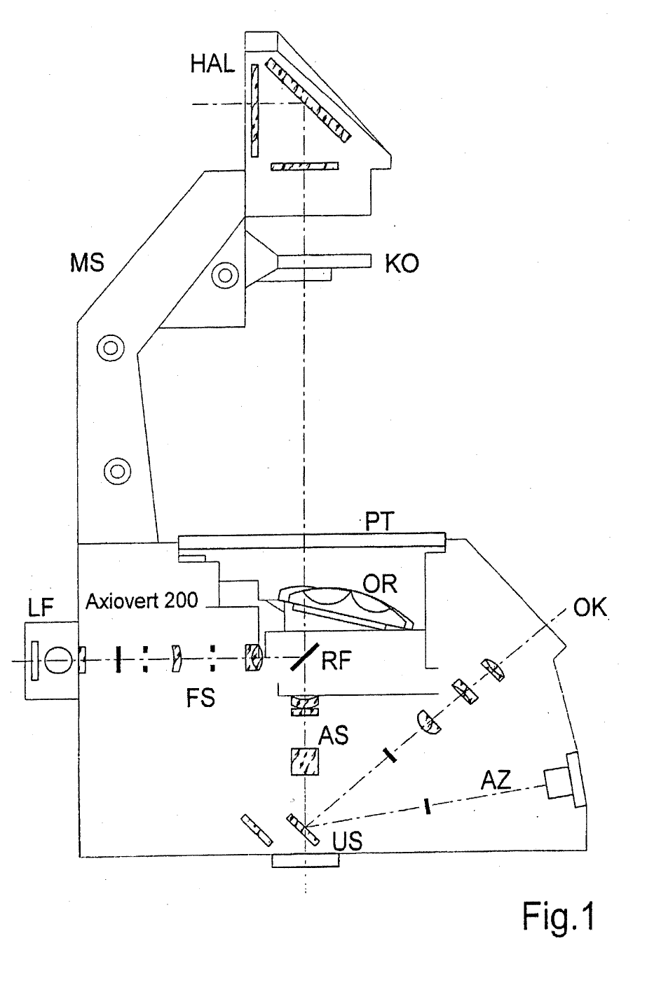

The beam path of an inverted microscope is shown schematically in FIG. 1. A halogen lamp HAL at the microscope stand MS illuminates an object located on the specimen table PT via a condenser KO. Located below the specimen table is an objective turret OR, shown without the objective lenses which are inserted therein, and a reflector RF which is part of a reflector turret RF, not shown, and which can be switched on to reflect a fluorescence excitation beam path FS of a light source LF. The imaging beam path AS is deflected in direction of the eyepiece OK (not shown) of the observer by a deflecting mirror US. Further, a recording beam path AZ is provided for photographic recordings.

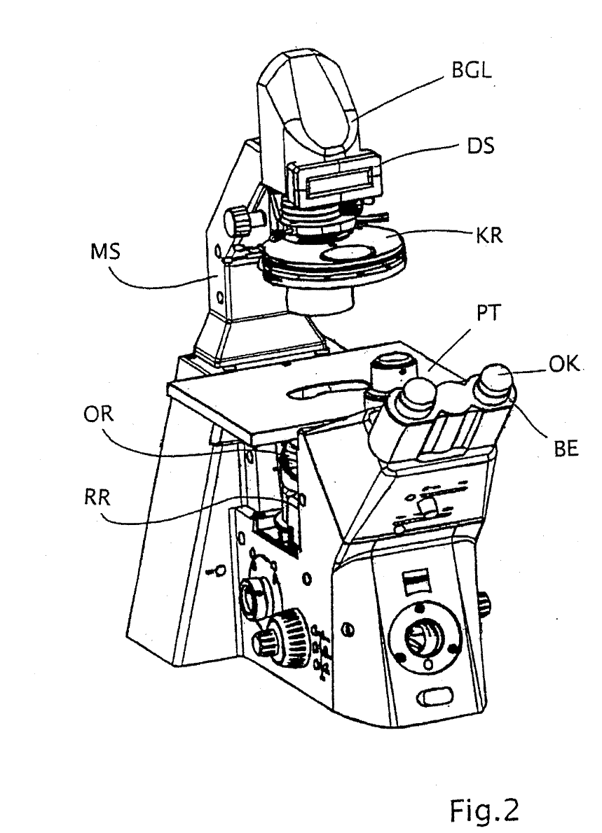

FIG. 2 is an oblique view showing the illumination device BLG followed by a condenser turret KR. Located below a specimen table PT is the objective turret OR, only part of which is shown, and a reflector turret RR which can preferably be adjusted by motor and which is outfitted, for example, with fluorescence splitters. The light from a light source LF for exciting fluorescent light strikes the splitter turret proceeding from lateral direction. Also shown is the binocular viewer BE with eyepieces OK for the observer. A display device DS, preferably an LCD display, is provided at about the eye level of the observer at the transmitted illumination device BL. Accordingly, the observer can look into the binocular viewer with relaxed posture and immediately have an overview of different adjusted positions such as lamp brightness, lamp voltage, type of objective, illumination mode, contrast module and can adjust these positions in a simple manner by means of control buttons provided on the microscope.

The display DS can advantageously be switched off in order to eliminate its light influence when observing through the binocular viewer. Further, it can advantageously be removed and can have a cable connection or wireless connection to the control computer of the microscope, so that it can be placed by the side of the observer, for example, when the observer wants to display recording conditions, for example. The display DS is used, among other purposes, to display the current position of the objective turret and the associated objective type (stored beforehand), the illumination state (incident light, transmitted light), lamp brightness, preferably by rising and falling bar lines and/or voltage indication.

In set mode, the magnification and type of contrasting (phase contrast, DIC) is adjusted for every turret position (for example, from a continuous list of all possible combinations).

In an advantageous manner, it is now possible to adjust the illumination and the contrasting method (brightfield, darkfield, phase contrast, DIC) simply by changing the position of the reflector turret. For this purpose, a plurality of contrasting methods with corresponding brightness values or illumination modes (light source switching, HAL, FL or HAL+FL) and positions of the condenser turret (swiveled-in phase ring or DIC) are stored for individual objectives. These values are changed automatically by changing the reflector turret (by motor). When the reflector turret is switched to a position with fluorescence filter, the illumination is automatically switched from HAL to FL (switching of light source).

Surprisingly, it has been shown that it is advantageous for the automation of a microscope, and, therefore, for convenience of use, when microscope components other than those mentioned above (objective turret, reflector turret) act as primary components such that they control other, secondary components when changing their switching state and, accordingly, when moving another optical component into the beam path of the microscope, so that a plurality of configurations which are defined and stored by the user as optimal for the user's observation requirements are adjusted without the user having to carry out further adjustments by introducing the primary component.

For this purpose, the microscope according to the invention has the following features:

at least one imaging beam path and at least one illumination beam path which is provided as a fluorescence beam path and/or transmitted light beam path,

at least one objective which can preferably be moved into the beam path in an electrically controlled manner,

a quantity of microscope components such as condenser, condenser turret, reflector turret, diaphragms and controls for illumination, which components influence these beam paths, wherein at least some of these microscope components are controllable electrically and/or the switching states of these components can be detected electrically;

a control unit which is connected with the electrically controllable and/or electrically detectable components and which has a storage for the switching states of these microscope components,

that at least a first microscope component is provided,

that at least a second, controllable microscope component is associated with this first component,

that when changing a first microscope component the second microscope component associated with it is switched corresponding to a switching state of the second microscope component which is stored for the current switching state of the first microscope component.

In this connection, it is advantageous when one of the first components is the reflector turret and at least one component for switching the illumination is associated, as second component, with this first component, wherein this component switches the incident or reflected beam path for switching the illumination. Also, a component for switching illumination which switches the transmitted light beam path can be associated with the reflector turret

In another advantageous arrangement of the invention, one of the first components is the reflector turret and a condenser turret is associated, as second component, with this first component, wherein the condenser turret can be switched between different contrasting methods (e.g., phase contrast, DIC, brightfield, darkfield, etc.).

Further, it is advantageous when one of the first components is the condenser turret and when a component for adjusting illumination is associated with this first component. This component for adjusting illumination can comprise means for regulating a lamp used for illumination and/or an adjustable neutral filter in the illumination beam path. A component for controlling the aperture diaphragm can also be associated with the first component, the condenser turret.

Another advantageous realization of the invention consists in that one of the first components is a shutter for the fluorescence beam path and in that a component for switching the transmitted light illumination is associated with this first component. According to the invention, a component for switching a front condenser lens and/or a component for controlling an aperture diaphragm can also be associated with the shutter for the fluorescence beam path.

Therefore, it is advantageously possible for the light source and/or illumination optics to be switched automatically to pre-stored values and/or positions when switching the condenser turret.

Also in an advantageous manner, an automatic switching of the light source and/or illumination optics to pre-stored values and/or positions can be carried out when switching a shutter for the fluorescence beam path.

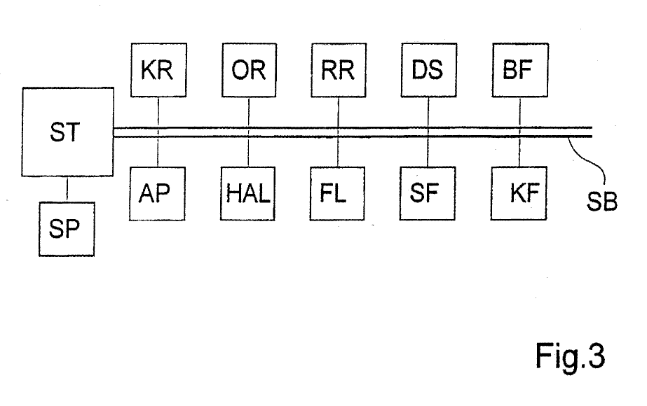

In an embodiment example (FIG. 3), a control unit ST is electrically connected, via a control bus SB, to the following microscope components: condenser turret KR, objective turret OR, reflector turret RR, turret for neutral glass filter ND, incident light illumination HAL, fluorescence illumination LF, shutter for the fluorescence illumination SF, a device for swiveling the front condenser lens KF in and out, aperture diaphragm AP and control panel BF. The control unit ST has a storage SP in which the control unit can store switching states of these microscope components and can read them out again.

The method described above, in which the contrasting method and the lamp brightness are adjusted simply by changing the position of the reflector turret, is carried out in a simple manner in that the illumination control HAL and FL and the condenser turret KP, as second component, are associated in the control unit ST with the first component, the reflector turret RR.

In another variant, the lamp brightness is associated with the condenser turret KR (as primary component) so as to be controlled by the second, secondary component comprising the lamp voltage and/or neutral glass filter turret ND. Further, the aperture diaphragm AP can also be associated, as secondary component, with the condenser turret KR. When the condenser turret KR is actuated, e.g., in order to switch to DIC type contrasting, the values for lamp brightness and aperture diaphragm position which were pre-stored by the user for this type of contrasting are adjusted by the control unit. Storage is carried out when setting up the microscope by actuating appropriate buttons on the control panel BF.

A further solution consists in that a shutter for the fluorescence excitation beam path FS is defined as primary component and a device for switching the halogen lamp HAL on and off, a device for swiveling a front condenser lens KF in or out in front of the condenser and/or the aperture diaphragm AP is assigned as secondary component to this shutter. When the shutter for the fluorescence excitation beam path FS is actuated, the halogen lamp HAL, the front condenser lens KF and the aperture diaphragm AP are then automatically moved into the positions which are associated with the position of the shutter and which were stored beforehand.

Lamp Brightness

The rapid increase in the lamp voltage controlled, for example, by a slider, stops at a preadjusted value, for example, 10.5 volts lamp voltage for color photography, and an audible signal is sounded. The control button can be pressed additionally for a further increase. Conversely, the rapid adjustment stops at a standby value and an audible signal is sounded.

The last lamp brightness adjusted is stored for each individual position of the objective and is reproduced automatically whenever the objective is changed. The lamp voltage is automatically reduced when an objective is changed in order to eliminate glare and to achieve faster switching of brightness.

The invention is not limited to the embodiment example shown herein. In particular, it is also applicable in upright microscopes. Further, it is possible to allocate primary and secondary microscope components in other ways than those mentioned herein.

1. Arrangement for controlling and/or displaying microscope functions, preferably in an inverted microscope, wherein a display is provided at or near the eye level of a user.

2. Arrangement according to claim 1, wherein the display is attached to the illumination unit of an inverted microscope.

3. Arrangement according to claim 1 or 2, wherein the display can be removed.

4. Arrangement according to claim 1 or 2, wherein the display is arranged at an upright microscope.

5. Arrangement according to one of the preceding claims, wherein an adjustment and/or storage of microscope functions is carried out via the display.

6. Method for controlling microscope functions, preferably using an arrangement according to claims 1 to 5, wherein an automatic switching of the light source and/or illumination optics is carried out to pre-stored values and/or positions when a reflector turret is switched.

7. Method according to claim 6, wherein the light source and/or illumination optics is/are switched between different contrasting methods and/or fluorescence methods.

8. Method for controlling microscope functions, preferably using an arrangement according to claims 1 to 5, wherein the lamp voltage is decreased automatically when an objective is changed.

9. Method for controlling microscope functions, preferably using an arrangement according to claims 1 to 5, wherein the increase in lamp voltage is stopped or slowed at a preadjusted value.

10. Method according to claim 9, wherein an audible signal is triggered at the preadjusted value.

11. Microscope comprising at least one imaging beam path and at least one illumination beam path which is provided as a fluorescence beam path and/or transmitted light beam path, at least one objective which can preferably be moved into the beam path in an electrically controlled manner, a quantity of microscope components such as condenser, condenser turret, reflector turret, diaphragms and controls for illumination, which components influence these beam paths, wherein at least some of these microscope components are controllable electrically and/or the switching states of these components can be detected electrically, a control unit which is connected to the electrically controllable and/or electrically detectable components and which has a storage for the switching states of these microscope components, characterized in that at least a first microscope component is provided, in that at least a second, controllable microscope component is associated with this first component, and in that, when changing a first microscope component, the second microscope component associated with it is switched corresponding to a switching state of the second microscope component which is stored for the current switching state of the first microscope component.

12. Microscope according to claim 11, characterized in that one of the first components is the reflector turret, and in that a component for switching the illumination is associated, as second component, with this first component.

13. Microscope according to claim 12, characterized in that the component for switching the illumination switches the incident beam path.

14. Microscope according to claim 12, characterized in that the component for switching the illumination switches the transmitted light beam path.

15. Microscope according to claim 11, characterized in that one of the first components is the reflector turret, and in that a condenser turret is associated, as second component, with this first component.

16. Microscope according to claim 15, characterized in that the condenser turret can be switched between different contrasting methods (e.g., phase contrast, DIC, brightfield, darkfield, and so on).

17. Microscope according to claim 11, characterized in that one of the first components is the condenser turret, and in that a component for adjusting illumination is associated with this first component.

18. Microscope according to claim 17, characterized in that the component for adjusting illumination comprises means for regulating a lamp used for illumination and/or an adjustable neutral filter in the illumination beam path.

19. Microscope according to claim 11, characterized in that one of the first components is the condenser turret, and in that a component for controlling an aperture diaphragm is associated with this first component.

20. Microscope according to claim 11, characterized in that one of the first components is a shutter for the fluorescence beam path, and in that a component for switching the transmitted light illumination is associated with this first component.

21. Microscope according to claim 11, characterized in that one of the first components is a shutter for the fluorescence beam path, and in that a component for switching a front condenser lens is associated with this first component.

22. Microscope according to claim 20, characterized in that one of the first components is a shutter for the fluorescence beam path, and in that a component for controlling an aperture diaphragm is associated with this first component.

23. Method for controlling microscope functions, preferably using an arrangement of a microscope according to claim 11, wherein an automatic switching of the light source and/or illumination optics to pre-stored values and/or positions is effected when switching a condenser turret.

24. Method for controlling microscope functions, preferably using an arrangement of a microscope according to claim 11, wherein an automatic switching of the light source and/or illumination optics to pre-stored values and/or positions is effected when switching a shutter for the fluorescence beam path.
